(19) United States
(12) Patent Application Publication
(10) Pub. No.: US 2015/0215114 A1
(43) Pub. Date: Jul. 30, 2015

(54) METHOD FOR GENERATING A SECURE CRYPTOGRAPHIC HASH FUNCTION

(71) Applicants: MOHAMMAD A. ALAHMAD, KUALA LUMPUR (MY); IMAD FAKHRI ALSHAIKHLI, KUALA LUMPUR (MY)

(72) Inventors: MOHAMMAD A. ALAHMAD, KUALA LUMPUR (MY); IMAD FAKHRI ALSHAIKHLI, KUALA LUMPUR (MY)

(21) Appl. No.: 14/167,902

(22) Filed: Jan. 29, 2014

(51) Int. Cl. H04L 9/08

(52) U.S. Cl. CPC H04L 9/0816

(57) ABSTRACT

A method for generating a secure cryptographic hash function supporting 256-512 bit digests is provided. A compression function based on a block cipher in the Davies-Meyer mode is used. A hash function is developed from this compression function using an iterative compression function with the Merkle-Damgård construction, finally resulting in a wide pipe construction in which the intermediate chaining value is at least twice the length of the output hash.

### BACKGROUND OF THE INVENTION

1. Field of the Invention

The present invention relates generally to cryptography, and particularly, to a method for generating a secure cryptographic hash function using the Merkle-Damgård construction based on a compression function developed from a block cipher in the Davies-Meyer mode.

2. Description of the Related Art

A cryptographic hash function is a hash function that takes an arbitrary block of data and returns a fixed-size bit string, the cryptographic hash value, such that any accidental or intentional change to the data will, with very high probability, change the hash value. The data to be encoded are typically called the “message”, and the hash value is sometimes called the “message digest” or, simply the “digest”. The ideal cryptographic hash function has four main properties: it is relatively easy to compute the hash value for any given message; it is typically infeasible to generate a message that has a given hash; it is typically infeasible to modify a message without changing the hash; and it is typically infeasible to find two different messages with the same hash.

Cryptographic hash functions have numerous information security applications, notably in digital signatures, message authentication codes (MACs), and other forms of authentication. They can also be used as ordinary hash functions, to index data in hash tables, for fingerprinting, to detect duplicate data or uniquely identify files, and as checksums to detect accidental data corruption. In fact, in information security contexts, cryptographic hash values are sometimes called digital fingerprints, checksums, or just hash values, even though all these terms stand for more general functions with rather different properties and purposes.

FIG. 2 illustrates the exemplary sure hash algorithm (SHA), SHA-1, cryptographic hash function (created by the United States National Security Agency) at work. It should be noted that even small changes in the source input (in the word “over” in this example) drastically change the resulting output; i.e., the so-called “avalanche effect”. There are several methods to use a block cipher to build a cryptographic hash function, specifically through a “one-way” compression function. In cryptography, a block cipher is a deterministic algorithm operating on fixed-length groups of bits, called “blocks”, with an unvarying transformation that is specified by a symmetric key. Block ciphers are important elementary components in the design of many cryptographic protocols, and are widely used to implement encryption of bulk data. In cryptography, a one-way compression function is a function that transforms a fixed-length input into a fixed-length output. The transformation is “one-way”, meaning that it is difficult, given a particular output, to compute inputs which compress to that output. One-way compression functions are not related to data compression, which, by definition, is invertible.

One-way compression functions are commonly used in the Merkle-Damgård construction inside cryptographic hash functions. A hash function must be able to process an arbitrary-length message into a fixed-length output. This can be achieved by breaking the input up into a series of equal-sized blocks, and operating on them in sequence using a one-way compression function. The compression function can either be specially designed for hashing or be built from a block cipher. A hash function built with the Merkle-Damgård construction, as illustrated in FIG. 3, is as resistant to collisions as is its compression function; i.e., any collision for the full hash function can be traced back to a collision in the compression function. The last block processed should also be unambiguously length padded, which factor is typically considered crucial to the security of this construction.

As shown in FIG. 3, the Merkle-Damgård hash function first applies an MD-compliant padding function to create an output whose size is a multiple of a fixed number (e.g., 512 or 1024) because compression functions cannot handle inputs of arbitrary size. The hash function then breaks the result into blocks of fixed size, and processes them one at a time with the compression function, each time combining a block of the input with the output of the previous round. In order to make the construction secure, Merkle and Damgård proposed that messages be padded with a padding that encodes the length of the original message. This is called “length padding” or “Merkle-Damgård strengthening”.

In FIG. 3, the one-way compression function transforms two fixed length inputs to an output of the same size as one of the inputs. The algorithm starts with an initial value, referred to as the “initialization vector” (IV). The IV is a fixed value which is algorithm or implementation specific. For each message block, the compression (or compacting) function ƒ takes the result so far, combines it with the message block, and produces an intermediate result i. The last block is padded with zeros as needed and bits representing the length of the entire message are appended.

In order to harden the hash further, the last result is then sometimes fed through a finalization function. The finalization function can have several purposes, such as compressing a bigger internal state (i.e., the last result) into a smaller output hash size or to guarantee a better mixing and avalanche effect on the bits in the hash sum. The finalization function is often built by using the compression function.

With regard to the aforementioned length padding, in order to be able to feed the message to the compression function, the last block needs to be padded with constant data (generally with zeroes) to a full block. For example, if the message to be hashed is “HashInput”, and the block size of the compression function is 8 bytes (64 bits), then the result is two blocks which appear as “HashInpu t0000000”. However, this is typically not enough since it would mean that distinct messages starting with the same data and terminated by zero or more bytes from the padding constant data would get fed into the reduction function using exactly the same blocks, producing the same final hash sum. In the above example, the modified message “HashInput00” would generate the same blocks as the original message “HashInput”.

In order to assist in preventing such generation, the first bit of the padded constant data typically must be changed. As the constant padding is generally made of zeroes, the first padding bit will be mandatorily changed into “1”. Thus, in the present example, the result would be “HashInpu t1000000”. In order to harden the hash even further, the length of the message can be added in an extra block. Following from the same example, the result is then three blocks: “HashInpu t1000000 00000009”.

In order to avoid ambiguity, the message length value typically must be resistant to length extensions. Most common implementations use a fixed bit-size (generally 64 or 128 bits in modern algorithms) and a fixed position at the end of the last block for encoding the message length value. This, however, can be wasteful since it means hashing one full extra block for the length value. Thus, a slight speed optimization is typically used by most modern hash algorithms. If there is space among the zeros padded to the last block, the length value can be padded there instead. In the present example, if the length value is encoded on 5 bytes (40 bits), then it would be padded in the final block as “00009”, rather than just “9” or with too many unnecessary zeroes. The end result would be of the form “HashInpu t1000009”. Most widely used hash functions, including SHA-1 and MD5, generally take this form. However, the construction has certain inherent flaws, including length-extension and generate-and-paste attacks, as well as the fact that the construction cannot be parallelized.

Due to various structural weaknesses of the Merkle-Damgård construction, especially the length extension problem and multi-collision attacks, the use of the “wide pipe” hash was developed to replace the Merkle-Damgård construction. The wide pipe hash is very similar to the Merkle-Damgård construction but has a larger internal state size, meaning that the bit-length that is internally used is larger than the output bit-length. If a hash of n bits is desired, the compression function takes 2n bits of chaining value and in bits of the message and compresses this to an output of 2n bits. Therefore, in a final step a second compression function compresses the last internal hash value (2n bits) to the final hash value (n bits). This can be performed as simply as discarding half of the last 2n bit output. SHA-224 and SHA-384 take this form since they are derived from SHA-256 and SHA-512, respectively. FIG. 4 illustrates the wide pipe hash construction, where the intermediate chaining values have been doubled.

It has been demonstrated that the wide pipe hash function can be made approximately twice faster, if the wide pipe state can be divided in half in the following manner: one half is input to the succeeding compression function when the other half is combined with the output of that compression function. The main idea of the hash construction is to feed-forward half of the previous chaining value to XOR it to the output of the compression function. Following this, the construction takes in a longer message block at each iteration than in the original wide pipe construction. Using the same compression function ƒ as before, it takes an n bit chaining value and n+m bits of the message. However, the price paid is the extra memory used in the construction for feed-forward. FIG. 5 illustrates the fast wide pipe hash construction, in which half of chaining value is used in the compression function.

Thus, a method of generating a secure cryptographic hash function addressing the aforementioned problems is desired.

### SUMMARY OF THE INVENTION

In embodiments of the present invention, a secure cryptographic hash function supporting 256-512 bit digests is developed. A compression function based on a block cipher in the Davies-Meyer mode is used. A hash function is developed from this compression function using an iterative compression function with the Merkle-Damgård construction, finally resulting in a wide pipe construction, in which the intermediate chaining value is at least twice the length of the output hash. An embodiment of a method for generating the secure cryptographic hash function includes the following steps:

(a) iteratively, for i=0 to 15, where i is an integer, applying an operation R on a state S of a block cipher C and an i-th subkey Kᵢ, where R=AK(S,Kᵢ)∘MC(S)∘SR(S)∘SB(S), where AK is a cryptographic AddRoundKey transformation, MC is a cryptographic MixColumns transformation, SR is a cryptographic ShiftRows transformation and SB is a cryptographic SubBytes transformation, where the SubBytes transformation applies an invertible S-box to all bytes of the state of the block cipher and the subkey, where the invertible S-box in hexadecimal representation is defined as:

| | 0 | 1 | 2 | 3 | 4 | 5 | 6 | 7 | 8 | 9 | a | b | c | d | e | f |
|---|---|---|---|---|---|---|---|---|---|---|---|---|---|---|---|---|
| 0 | 63 | 7c | 77 | 7b | f2 | 6b | 6f | c5 | 30 | 01 | 67 | 2b | fe | d7 | ab | 76 |
| 1 | ca | 82 | c9 | 7d | fa | 59 | 47 | f0 | ad | d4 | a2 | af | 9c | a4 | 72 | c0 |
| 2 | b7 | fd | 93 | 26 | 36 | 3f | f7 | cc | 34 | a5 | e5 | f1 | 71 | d8 | 31 | 15 |
| 3 | 04 | c7 | 23 | c3 | 18 | 96 | 05 | 9a | 07 | 12 | 80 | e2 | eb | 27 | b2 | 75 |
| 4 | 09 | 83 | 2c | 1a | 1b | 6e | 5a | a0 | 52 | 3b | d6 | b3 | 29 | e3 | 2f | 84 |
| 5 | 53 | d1 | 00 | ed | 20 | fc | b1 | 5b | 6a | cb | be | 39 | 4a | 4c | 58 | cf |
| 6 | d0 | ef | aa | fb | 43 | 4d | 33 | 85 | 45 | f9 | 02 | 7f | 50 | 3c | 9f | a8 |
| 7 | 51 | a3 | 40 | 8f | 92 | 9d | 38 | f5 | bc | b6 | da | 21 | 10 | ff | f3 | d2 |
| 8 | cd | 0c | 13 | ec | 5f | 97 | 44 | 17 | c4 | a7 | 7e | 3d | 64 | 5d | 19 | 73 |
| 9 | 60 | 81 | 4f | dc | 22 | 2a | 90 | 88 | 46 | ee | b8 | 14 | de | 5e | 0b | db |
| a | e0 | 32 | 3a | 0a | 49 | 06 | 24 | 5c | c2 | d3 | ac | 62 | 91 | 95 | e4 | 79 |
| b | e7 | c8 | 37 | 6d | 8d | d5 | 4e | a9 | 6c | 56 | f4 | ea | 65 | 7a | ae | 08 |
| c | ba | 78 | 25 | 2e | 1c | a6 | b4 | c6 | e8 | dd | 74 | 1f | 4b | bd | 8b | 8a |
| d | 70 | 3e | b5 | 66 | 48 | 03 | f6 | 0e | 61 | 35 | 57 | b9 | 86 | c1 | 1d | 9e |
| e | e1 | f8 | 98 | 11 | 69 | d9 | 8e | 94 | 9b | 1e | 87 | e9 | ce | 55 | 28 | df |
| f | 8c | a1 | 89 | 0d | bf | e6 | 42 | 68 | 41 | 99 | 2d | 0f | b0 | 54 | bb | 16; |

(b) iteratively, for i=0 to 15, transforming the i-th subkey Kᵢ as Kᵢ₊₁=AC∘MC SR∘SB(Kᵢ), where AC is a cryptographic AddRoundConstant transformation and K₀ is an initial master key;

(c) defining a compression function CF iteratively, for i=0 to 15, as Hᵢ₊₁=CF(Hᵢ,Mᵢ)=C(Hᵢ,Mᵢ)⊕Hᵢ, where Hᵢ is an i-th chaining value, Mᵢ is an i-th message block, and H₀ is a fixed initial chaining value, where the iterative compression operation Hᵢ₊₁=CF(Hᵢ,Mᵢ) pads the set of message blocks to an expanded message containing/blocks, where l is an integer; and

(d) truncating the l-th chaining value Hₗ₊₁ to output n left-most bits of Hₗ₊₁, where n represents a size of an initial message digest, the truncated chaining value being a secure cryptographic hash function.

These and other features of the present invention will become readily apparent upon further review of the following specification and drawings.

### BRIEF DESCRIPTION OF THE DRAWINGS

FIG. 1 is a block diagram illustrating a system for implementing a method of generating a secure cryptographic hash function according to the present invention.

FIG. 2 illustrates operation of the prior art SHA-1 cryptographic hash function.

FIG. 3 illustrates operation of the prior art Merkle-Damgård construction of cryptographic hash functions.

FIG. 4 illustrates operation of the prior art “wide pipe” variant of the Merkle-Damgård construction of cryptographic hash functions.

FIG. 5 illustrates operation of the prior art “fast wide pipe” variant of the Merkle-Damgård construction of cryptographic hash functions.

FIGS. 6A, 6B, 6C, 6D, 6E, 6F, 6G, 6H, 61, 6J and 6K respectively illustrate the truncated differential for a 10-round attack on a 512-bit cryptographic hash function generated by the method of generating a secure cryptographic hash function according to the present invention.

Unless otherwise indicated, similar reference characters denote corresponding features consistently throughout the attached drawings.

### DETAILED DESCRIPTION OF THE PREFERRED EMBODIMENTS

In embodiments of the present invention, a cryptographic hash function supporting 256-512 bit digests is developed. A compression function based on a block cipher is developed. The compression function is based on the block cipher in the Davies-Meyer mode. A hash function is developed from this compression function using an iterative compression function with the Merkle-Damgård construction, finally resulting in a wide pipe construction, in which the intermediate chaining value is at least twice the length of the output hash.

The inventive wide pipe hash function has an internal state of 1024 bits, supporting digests of between 1 and 512 bits. For security reasons, a minimal output of 256 bits is recommended. As will be described in greater detail below, versions with output lengths of both 256 bits and 512 bits are contemplated. All variations, however, differ only in the number of bits that are truncated at the output of the same method. The initial block cipher is an substitution-permutation (SP) network with 16 rounds, designed according to the “wide trail” strategy.

The block cipher has a state of 1024 bits and supports 1024-bit keys. The state, as well as the key, is an 8×16 matrix of bytes. In the following the individual bytes of the state matrix are represented as a_{i,j} and the individual bytes of the key matrix are represented as b_{i,j}, where i=0, . . . , 7 and j=0, . . . , 15. In each of the 16 rounds, the state S undergoes four byte-oriented transformations, such that round R may be represented as R=AK∘MC∘SR∘SB, where AK, MC, SR and SB respectively stand for the conventional advanced encryption standard (AES) cryptographic operations of AddRoundKey, MixColumns, ShiftRows and SubBytes. An additional AddRoundKey is performed at the beginning of the state update transformations (commonly referred to as “key pre-whitening).

The 1024-bit subkey Kᵢ used in the i-th round is produced from the previous subkey through a similar operation: Kᵢ=AC∘MC∘SR∘SB(Kᵢ₋₁), where AC stands for AddRoundConstant. The pre-whitening key K₀ is the initial master key. The round and key schedule transformations are the standard operations used in most of the Rijndael-based primitives, summarized below. In the following, the superscripts “new” and “old” are used to denote the updated and previous values, respectively, for the bytes (or columns of the matrix).

The SubBytes (SB) transformation is the only non-linear part of the cipher. It consists of an independent application of an 8×8 bit S-box to all of the bytes of the state (or the subkey), etc. In other words, a_{i,j}^{new}=S(a_{i,j}^{old}) and b_{i,j}^{new}=S(b_{i,j}^{old}). Here, the invertible AES S-box S(·) is used for this purpose, which is a composition of a finite field inversion and an affine transformation. The exact definition of the S-box used in the present method is given below in Table 1 in the form S(X₁X₂)=Y.

TABLE 1
SubBytes S-box Values

| X₁/X₂ | 0 | 1 | 2 | 3 | 4 | 5 | 6 | 7 | 8 | 9 | a | b | c | d | e | f |
|---|---|---|---|---|---|---|---|---|---|---|---|---|---|---|---|---|
| 0 | 63 | 7c | 77 | 7b | f2 | 6b | 6f | c5 | 30 | 01 | 67 | 2b | fe | d7 | ab | 76 |
| 1 | ca | 82 | c9 | 7d | fa | 59 | 47 | f0 | ad | d4 | a2 | af | 9c | a4 | 72 | c0 |
| 2 | b7 | fd | 93 | 26 | 36 | 3f | f7 | cc | 34 | a5 | e5 | f1 | 71 | d8 | 31 | 15 |
| 3 | 04 | c7 | 23 | c3 | 18 | 96 | 05 | 9a | 07 | 12 | 80 | e2 | eb | 27 | b2 | 75 |
| 4 | 09 | 83 | 2c | 1a | 1b | 6e | 5a | a0 | 52 | 3b | d6 | b3 | 29 | e3 | 2f | 84 |
| 5 | 53 | d1 | 00 | ed | 20 | fc | b1 | 5b | 6a | cb | be | 39 | 4a | 4c | 58 | cf |
| 6 | d0 | ef | aa | fb | 43 | 4d | 33 | 85 | 45 | f9 | 02 | 7f | 50 | 3c | 9f | a8 |
| 7 | 51 | a3 | 40 | 8f | 92 | 9d | 38 | f5 | bc | b6 | da | 21 | 10 | ff | f3 | d2 |
| 8 | cd | 0c | 13 | ec | 5f | 97 | 44 | 17 | c4 | a7 | 7e | 3d | 64 | 5d | 19 | 73 |
| 9 | 60 | 81 | 4f | dc | 22 | 2a | 90 | 88 | 46 | ee | b8 | 14 | de | 5e | 0b | db |
| a | e0 | 32 | 3a | 0a | 49 | 06 | 24 | 5c | c2 | d3 | ac | 62 | 91 | 95 | e4 | 79 |
| b | e7 | c8 | 37 | 6d | 8d | d5 | 4e | a9 | 6c | 56 | f4 | ea | 65 | 7a | ae | 08 |
| c | ba | 78 | 25 | 2e | 1c | a6 | b4 | c6 | e8 | dd | 74 | 1f | 4b | bd | 8b | 8a |
| d | 70 | 3e | b5 | 66 | 48 | 03 | f6 | 0e | 61 | 35 | 57 | b9 | 86 | c1 | 1d | 9e |
| e | e1 | f8 | 98 | 11 | 69 | d9 | 8e | 94 | 9b | 1e | 87 | e9 | ce | 55 | 28 | df |
| f | 8c | a1 | 89 | 0d | bf | e6 | 42 | 68 | 41 | 99 | 2d | 0f | b0 | 54 | bb | 16 |

The ShiftRows (SR) transformation performs a cyclic shift of the rows of the matrix on different offsets that depend on the row index. The value of the offsets rₐⁱ and r_{b}ⁱ, where 1=0, . . . 7, are different for the state and key schedules, respectively:

$${a}_{i , j}^{new} = {a}_{i , j + {r}_{a}^{i} mod 16}^{old} and {b}_{i , j}^{new} = {b}_{i , j + {r}_{b}^{i} mod 16}^{old} . {□}^{*}$$

The specific values for the offsets used in the present method are given below in Table 2.

TABLE 2
Offsets used in ShiftRows

| Row | State Offset rₐⁱ | Key Schedule Offset r_{b}ⁱ |
|---|---|---|
| 0 | 0 | 0 |
| 1 | 1 | 2 |
| 2 | 2 | 4 |
| 3 | 3 | 5 |
| 4 | 5 | 6 |
| 5 | 6 | 8 |
| 6 | 7 | 9 |
| 7 | 8 | 10 |

The MixColumns (MC) transformation provides the diffusion among the bytes. The MixColumns transformation is a multiplication of the columns aⱼ, bⱼ of the state/subkeys by a matrix M: aⱼ^{new}=M·aⱼ^{old} and bⱼ^{new}=M·bⱼ^{old}, where the matrix M is defined as:

$$M = ( \begin{matrix}02 & 0 c & 06 & 08 & 01 & 04 & 01 & 01 \\ 01 & 02 & 0 c & 06 & 08 & 01 & 04 & 01 \\ 01 & 01 & 02 & 0 c & 06 & 08 & 01 & 04 \\ 04 & 01 & 01 & 02 & 0 c & 06 & 08 & 01 \\ 01 & 04 & 01 & 01 & 02 & 0 c & 06 & 08 \\ 08 & 01 & 04 & 01 & 01 & 02 & 0 c & 06 \\ 06 & 08 & 01 & 04 & 01 & 01 & 02 & 0 c \\ 0 c & 06 & 08 & 01 & 04 & 01 & 01 & 02\end{matrix} ) . \qquad ( 1 )$$

It should be noted that the same matrix is used for both the state and key schedules. The multiplication is performed in GF(2⁸) defined with the irreducible polynomial x⁸+x⁴+x³+x+1.

The AddRoundKey (AK) transformation allows the 1024 bit subkey to be exclusive or (XOR)ed to the state. The XOR can be seen as byte-wise; i.e., a_{i,j}^{new}=a_{i,j}^{old}⊕b_{i,j}. The AddRoundConstant (AC) allows a constant Cᵢ to be XORed to the subkey Kᵢ. Similar to the AddRoundKey transformation, the AddRoundConstant transformation can be represented as a byte-wise operation. The value of the constants is dependent on the index i. The constant Cᵢ is defined as:

$${C}_{i} = ( \begin{matrix}ff & ff & ff & ff & … & ff & ff & ff & ff \\ ff & ff & ff & ff & … & ff & ff & ff & ff \\ ff & ff & ff & ff & … & ff & ff & ff & ff \\ ff & ff & ff & ff & … & ff & ff & ff & ff \\ ff & ff & ff & ff & … & ff & ff & ff & ff \\ ff & ff & ff & ff & … & ff & ff & ff & ff \\ ff & ff & ff & ff & … & ff & ff & ff & ff \\ i ⊕ 0 & i ⊕ 1 & i ⊕ 2 & i ⊕ 3 & … & i ⊕ c & i ⊕ d & i ⊕ e & i ⊕ f\end{matrix} ) . \qquad ( 2 )$$

Once the cipher C has been built, a standard approach is used to build the hash function which is based on the cipher C. The first step is defining the compression function CF, which requires two inputs: the 1024 bit chaining value Hᵢ and the 1024 bit message Mᵢ, which produces a 1024 bit chaining value Hᵢ₊₁ with a Davies-Meyer mode of the cipher C; i.e., Hᵢ₊₁=CF(Hᵢ,Mₜ)=C(Hᵢ,Mᵢ)⊕Hᵢ. This compression function CF is used to build a hash function using the Merkle-Damgård construction. Thus, an initial chaining value H₀ is fixed equal to the first 128 bytes of the fractional part of π (shown below in Table 3 in hexadecimal). The message M is then padded and this expanded message is split into 1024 bit blocks Mᵢ. Next, all message blocks are iterated using the compression function based on the Merkle-Damgård construction:

H₀=IV (3)

Hᵢ₊₁=CF(Hᵢ,Mᵢ) (4)

TABLE 3
The Initial Chaining Value H₀

| | | | | | | | | | | | | | | | |
|---|---|---|---|---|---|---|---|---|---|---|---|---|---|---|---|
| 24 | 3f | 6a | 88 | 85 | a3 | 08 | d3 | 13 | 19 | 8a | 2e | 03 | 70 | 73 | 44 |
| a4 | 09 | 38 | 22 | 29 | 9f | 31 | d0 | 08 | 2e | fa | 98 | ec | 4e | 6c | 89 |
| 45 | 28 | 21 | e6 | 38 | d0 | 13 | 77 | be | 54 | 66 | cf | 34 | e9 | 0c | 6c |
| c0 | ac | 29 | b7 | c9 | 7c | 50 | dd | 3f | 84 | d5 | b5 | b5 | 47 | 09 | 17 |
| 92 | 16 | d5 | d9 | 89 | 79 | fb | 1b | d1 | 31 | 0b | a6 | 98 | df | b5 | ac |
| 2f | fd | 72 | db | d0 | 1a | df | b7 | b8 | e1 | af | ed | 6a | 26 | 7e | 96 |
| ba | 7c | 90 | 45 | f1 | 2c | 7f | 99 | 24 | a1 | 99 | 47 | b3 | 91 | 6c | f7 |
| 08 | 01 | f2 | e2 | 85 | 8e | fc | 16 | 63 | 69 | 20 | d8 | 71 | 57 | 4e | 69 |

When the expanded message contains l blocks, the output Hᵢ₊₁ is used to produce the final hash based on truncation; i.e., the hash of M is tr(Hᵢ₊₁), where tr(x) truncates the left-most bits of x, depending on the hash size. Thus, for 256 bit digests, tr(x) outputs the 256 left-most (i.e., the most significant) bits of x, while for a 512 bit digest, this number is 512. In general, for C-n, tr(x) outputs the n most significant bits of the last produced chaining value Hᵢ₊₁.

The padding procedure produces the expanded message Mₑ from the original input message M. The padding assures that the length (in bits) of M is properly encoded into the expanded message Mₑ, and the length of Mₑ is divisible by 1024. In order to achieve this, a trivial padding is performed by attaching a required number of 0's to make the last message block 1024 bits. An additional message block is also always introduced at the end, containing the length of M only. If M has t bits, then from M, M_{ē} is first produced as M_{ē}=M00 . . . 0, where the number of 0's is 1024−t·mod (1024) when t is not divisible by 1024. Otherwise, no 0's are attached. Next, and additional 1024 bit block is attached which contains 1024−64=960 0's, while the last 64 bits are equal to t; i.e., the expanded message is defined as Mₑ=Mₑ00 . . . 0 t binary.

The present hash function is little endian oriented; i.e., it regards 64 bit words as 8 bytes in reverse order, with the least significant bit placed first. The mapping of the byte sequence to the matrix of the state (or the key schedule) is from left to right, and top row to bottom row. For example, the 128 byte sequence a₁, . . . , a₁₂₈ is mapped to the matrix as:

$$\begin{matrix}{a}_{1} & {a}_{2} & {a}_{3} & … & {a}_{16} \\ {a}_{17} & {a}_{18} & {a}_{19} & … & {a}_{32} \\ … & … & … & … & … \\ {a}_{113} & {a}_{114} & {a}_{115} & … & {a}_{128}\end{matrix}$$

The pseudo-code of state round, keyschedule round, cipher C and hash function Hash are given below in algorithms 1-4.

Algorithm 1: State Round(S,Kᵢ)

S ← SubBytes(S)
S ← ShiftRows(S)
S ← MixColumns(S)
S ← AddRoundKey(S,Kᵢ)
end

Algorithm 2: KeySchedule Round(Kᵢ,i)

Kᵢ₊ₗ ← SubBytes(Kᵢ)
Kᵢ₊ₗ ← ShiftRows(Kᵢ₊ₗ)
Kᵢ₊ₗ ← MixColumns(Kᵢ₊ₗ)
Kᵢ₊ₗ ← AddRoundConstant(Kᵢ₊ₗ, i)
end

Algorithm 3: Cipher C(P,K)

S ← AddRoundKey (P,K) K₀ ← K
for i = 0 to 15 do

Kᵢ₊ₗ ← KeySchedule Round(Kᵢ,i)
S ← State Round(S)

end for
end

Algorithm 4: Hash(M)

M₀|M₁| ... |Mₗ ← padded(M) H₀ = IV
for i = 0 to l do

Hᵢ₊ₗ = C (Hᵢ, Mᵢ)⊕Hᵢ

end for
output truncated(Hₗ)
end

A list of test vectors for the 512-bit Hash hash function is given in Table 4 below. As shown in the third test vector, the typographical error “dag” yields a significantly different result in the vector.

TABLE 4
Test Vectors for Hash-512

| Test Vector | |
|---|---|
| # | Hash Content |
| 1 | Hash(“”) |
| | 8798dbba48ffd3b62e239b549499c09b |
| | 3d4637273489f9061f5e1d8d214e31ae |
| | 1dc13d88a561c5594c9937ee864140e9 |
| | 7f7b93ffd27e79251d4755a20eca60a4 |
| 2 | Hash(“The quick brown fox jumps over the lazy dog”) |
| | 9b182c6da0010a92e6df1dd67515764b |
| | 53a909aecc9be8dbf1c47bf876b4be42 |
| | 7b96491fbf8e2e90453b4ac9cabf4b5d |
| | 73394019ca7801d11307e8d000eed3e2 |
| 3 | Hash(“The quick brown fox jumps over the lazy dag”) |
| | 257269675f2d432ba8dbece0b25d4ac9 |
| | a95450c9788a6ef65cee1d1e349b7ed4 |
| | a13e0302d0d8204f17832933896ac7e4 |
| | 4b9709fd6ddb0f86732200955b51648e |

With regard to security of the mode, it should be noted that two widely-applied techniques for construction of hash functions are used in the present method, namely, the Davies-Meyer mode and the Merkle-Damgård construction. The security of the single-block-length block cipher modes have been analyzed and it is well known in the art that the Davies-Meyer mode has an asymptotically optimal bound for collision, along with pre-image resistance; i.e., the number of queries to the underlying cipher with a randomly chosen key (i.e., a black box access) to find collisions or a pre-image is roughly as predicted by the generic bound. Thus, this mode is secure against the standard attacks and shortcut attacks that can be found only by exploiting a weakness in the block cipher (but not in the mode). Thus, the present hash function is secure against the traditional attacks as long as the cipher C is secure. The Merkle-Damgård construction is an approach for building a collision-resistant hash function from a collision resistant compression function. In other words, if the hash function applies appropriate padding and the initial value is fixed, then the hash function is collision-resistant as long as the compression function has the same property. It should be noted that in the present hash function, the initial value is fixed and the padding is as required, thus, for collision resistance, the focus is only typically on the compression function.

The wide pipe construction, as discussed above, was developed to strengthen the security of the standard Merkle-Damgård construction against a variety of generic attacks. Most of these attacks use the fact that the standard single-pipe chaining value and internal state can be insufficient against attacks that target the intermediate chaining values. Particular attacks include length extension attacks, second pre-image attacks, multi-collisions, and the herding attack. In a length extension attack, once the attacker has a single collision, the attacker can produce many more colliding message pairs. Assuming that H(·) is a single-pipe hash, and M₁, M₂ are such that H(M₁)=H (M₂), then for any M, H (M₁|M)=H(M₂|M), thus the pair (M₁|M, M₂|M) is also a colliding pair. However, for a wide-pipe hash function (such as in the present inventive hash function), in general, this is not true. The initial message pair M₁, M₂ collides only on half of the bits; the other half is truncated, and does not necessarily produce collisions. Thus, the extending of the colliding pair with an additional message results in different input chaining values for the last compression function and, most likely, different hash values.

In the second pre-image attack, when the hashed message has l blocks (i.e.,/invocations of compression functions), the complexity of finding a second pre-image is 2ⁿ⁻¹ instead of the generic 2ⁿ. This is due to the fact that if the attacker is able to find a second pre-image of any of the intermediate chaining values, then he will succeed in finding a pre-image for the entire hash. Thus, instead of one final target (the digest), the attacker can aim at any of the l n-bit values. However, as in the present inventive hash function, the intermediate chaining values have at least 2n bits, and the complexity of finding a second pre-image for these values is at least 2²ⁿ (instead of 2ⁿ as in single-pipe). Thus, the present wide-pipe hash function is typically resistant against this type of generic attack,

In a multi-collision attack, producing multi-collisions (i.e., many different messages hash to the same value) has much lower complexity than the generic bound. It has been shown that for a single-pipe MD hash function, one can produce 2^{t}-collisions with only t·2^{n/2} calls to the compression function. In the multi-collision attack, sequential collisions are created for the consecutive compression function calls. In other words, first a colliding message pair (M₁¹, M₂¹) is found for the first compression function, then (M₁², M₂²) for the second (the input chaining value coincides with the output of the previous), and then keeps repeating this procedure for all t compression function calls. Then, all 2^{t} messages Mᵢ₁¹|Mᵢ₂²| . . . |Mᵢₗ^{l}, iⱼε1, 2 hash to the same value. Again, to succeed with the above attack, there has to be able to be found collisions (for the compression function), with a time complexity of finding collisions for the whole hash. However, in the present inventive double-pipe hash function, finding the intermediate collisions requires an effort of at least 2^{n compression function invocations. Therefore, the present hash is typically impervious to such a multi-collision attack.}

In a herding attack, the attacker presents a digest h, and then for an arbitrary message M the attacker is able to find M₂ such that H (M|M₂)=h. The main idea behind the herding attack is the production of a so-called “diamond structure”. In brief, the attack is based, once again, on producing collisions for the intermediate chaining values. As with the above examples of attacks, the present inventive hash is typically impervious to this type of attack due to its wide-pipe design.

The wide trail strategy is one of the most popular approaches for designing block ciphers and cryptographic hash functions which are resistant against differential and linear attacks. The diffusion layer in SP ciphers can be chosen in such a way to ensure a high number of differentially (or linearly) active S-boxes in any round-reduced characteristic. Two basic concepts are used for applying the wide trail: branch number and alternation of two different round transformations (which, in fact, can be combined into a single one). The branch number assures a minimal number of active S-boxes in any two-round characteristic. As in the present cipher C, the diffusion layer is based on maximum distance separable (MDS) code, the branch number is maximal and equals 9; i.e., any two-round differential (or linear) characteristic has at least nine active S-boxes. The alternating transformations are achieved with two different linear layers. In the present cipher C, these are the ShiftRows and MixColumns operations. As ShiftRows moves each row of the matrix to a different position, any four-round trail has 9×9=81 active S-boxes. As will be seen below, this lower bound can be used to prove resistance of the present hash function against various attacks.

Collision attacks on hash functions are based on finding differential trails with zero output difference. However, unlike differential distinguishers, where the probability can be as low as 2⁻ⁿ for an n-bit hash, the trails for collisions have to have at least 2^{-n/2}, otherwise a generic collision-finding algorithm would have lower complexity. As will be seen below, no differential trail exists for the present cipher C with a probability higher than 2⁻ⁿ, which can immediately allow a conclusion that collision attacks based on differential trails are typically not applicable to the present hash function. Another type of collision attack is based on the use of weak modes for the compression function. However, as already shown, the mode of the present hash function is secure. It should be further emphasized that the use of the Merkle-Damgård construction assures that since the present compression function is collision resistant, then the whole hash function is equally collision resistant.

The second pre-image attacks for a hash function based on secure modes usually exploit the weak message expansion and, in particular, the low diffusion. Most of these attacks are based on the meet-in-the-middle (MITM) attack and the recent improvement in the form of “splice and cut”. Although no sufficient conditions are currently available that ensure the compression function is secure against pre-image attacks, it is generally desirable to have a high diffusion in the message expansion. In the present inventive hash function, the compression function is based on the cipher C, which has a very high diffusion in the key schedule. It should be noted that in each round of the cipher, the whole key is used, and after only three rounds, the key schedule achieves a full diffusion of the bits of the key. Thus, it is expected that pre-image attacks cannot be launched on very high numbers of rounds. By using the partial matching technique and chunk separation, there can be launched a pseudo-pre-image attack on eight rounds of the 512-bit implementation of the present hash function, with about 2⁵⁰⁷ time and memory complexity. It should be further noted that shortcut attacks that exploit weak modes are discarded, as well as the mode used in the present hash being provably relatively secure against pre-image attacks.

The following examines the resistance of the present cipher C against the two popular forms of non-trivial distinguishing attacks, differential and linear cryptanalysis. Here, the claimed security level of the examined cipher will be only in accordance to the application for the hash function. As the maximal output size of Hash is 512 bits (all other versions have smaller outputs, thus generic attacks have lower complexity), only the 512 bit implementation is examined. Thus, it remains to be proven that no differential and linear attacks on cipher C exist with complexity lower than 2⁵¹².

With regard to linear attacks, it has already been shown that the cipher C follows the wide trail strategy, thus any 4-round trail has at least 81 active S-boxes. The best linear bias of the S-box used in cipher C is 2⁻³, thus the probability of any 4-round linear trail is, at most, 2^{-3·31}=2⁻²⁴³, while for any 12-round trail it is, at most, 2^{3·(-243)}=2⁻⁷²⁹. Thus, the cipher C achieves the claimed security level of 512 against linear cryptanalysis. It should be noted that the low probability linear trail 2⁻⁷²⁹ requires an amount of approximately 2¹⁴⁵⁸ pairs of plaintext-ciphertext, which exceeds the entire codebook, thus the security level of the cipher against linear cryptanalysis is actually 1024 bits, for example.

For standard differential attacks, standard differential attacks and, in particular, single-key differential trails are first examined. When there is no difference in the key of cipher C (i.e., there is no difference in the message block of Hash), the resistance against differential attacks comes from the wide trail strategy: the maximal differential propagation probability of the S-box is 2⁻⁶, and any four-round differential trail has 81 active S-boxes. Thus, the probability of any four-round differential trail is 2^{-6·81}=2⁻⁴⁸⁶ while the probability of any eight-round trails is 2^{-2·486}=2⁻⁹⁷². Therefore, the low probability can suffice to prove the claimed security bound of 512 bits. Better bounds (i.e., lower probability trails) can be proven when trails are on 12 rounds, in which case the security level of 1024 bits is achieved. This, however, is avoided, as the present hash requires a security level of only 512 bits.

Related-key differential attacks on cipher C do not improve the complexity of the best attacks. This is due to the fact that the key schedule of cipher C undergoes the same (or very similar) transformations. Thus, the probability of any related-key differential characteristic, only in the key schedule, would be, at most, 2⁻⁹⁷² for eight rounds. When cipher C is used in the hash function mode (as in the present inventive hash), the attacker has the freedom to choose the key. Examining the situation where tighter bounds on probability are obtained, from the wide trail strategy it follows that any two-round trail has at least 9 active S-boxes and any four-round has 81 active S-boxes. Thus, any six consecutive rounds have 90 active S-boxes and the probability of such a differential trail is 2^{-6·90}=2⁻⁵⁴⁰; i.e., it is lower than 2⁻⁵¹² (which is needed, since the present implementation is, for example, a 512-bit hash). The attacker can use message modification and choose the value of the state and the subkey in order to pass some rounds for free. However, out of all 16 rounds, the attacker has to pass 11 rounds with the modification. As both the state and the key schedule are highly complex, it is believed that this is relatively difficult to achieve, and it is estimated that only 2 to 4 rounds can be passed for free with message modification. This brings the total number of attacked rounds to 7⁻⁹ (2, 3, 4 rounds for free plus 5 rounds probabilistically).

Truncated differential attacks became popular as a form of analysis of byte-oriented primitives after the introduction of the Rebound attack and Super S-boxes. These techniques have shown that the message modification combined with truncated differential can significantly increase the number of attacked rounds in frameworks such as known-key distinguishers for block ciphers or hash function attacks. Moreover, it is typically not known in advance how many rounds can be passed for free when using message modification. In the following, it is assumed that this number is four, as this is the present state-of-the-art. However, the large security margin in the present hash assures that only significant progress can influence the security of the present hash function.

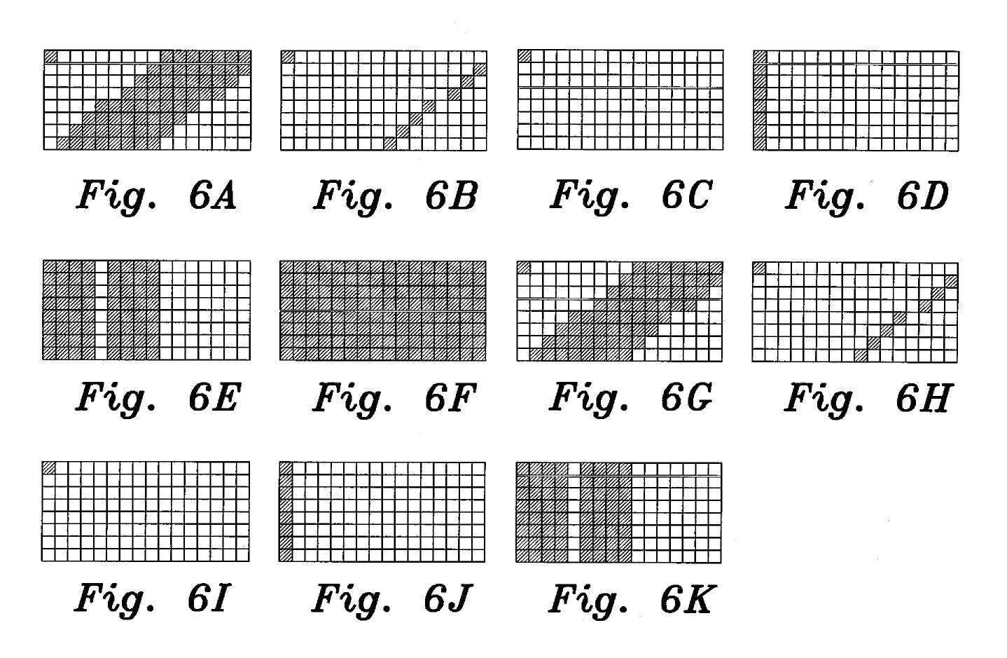

Examining a truncated differential attack on 10 rounds of the 512-bit Hash, the number of active S-boxes in the trail is as follows: 64→8→1→8→64→128→64→8→1→8→64. The differential is shown in FIGS. 6A-6K. Assuming that the four middle rounds, 8→64→128→64→8, are part of the inbound phase of the rebound attack, this is passed for free. The remaining six rounds (i.e., the first three and the last three) are the outbound phase, and are passed probabilistically. The probability of this phase is 2^{2·(-56)}=2⁻¹¹². For each transition 8→1, it is 2⁻⁵⁶, while for the rest (1→8, 8→64), the probability is 1. The complexity of finding a conforming pair for the inbound phase is 2²⁸⁰ time and 2⁶⁴ memory. Thus, the total complexity of the attack is 2¹¹²+2⁸⁰=2³⁹² time and 2⁶⁴ memory.

Slide attacks exploit rounds self-similarity and can be devastating for launching attacks on ciphers that use completely equal round transformations. To stop this type of attacks, round constants are introduced. Cipher C does not typically employ constants as part of the state transformations, however the key schedule applies the AddRoundConstant operation which assures that each round of the key schedule is different (it should be noted that the round constants Cᵢ depend on the round index i). Any slid pair (with one or a few rounds apart that is completely identical at the beginning) has to differ in the following round in at least 16 bytes of the subkey. The entire bottom row would be different as the round index is different. This can lead to a very fast expansion of the key difference (between the elements of the slid pair) in the few consecutive rounds which, in turn, assures a high number of active S-boxes. Thus, slide attacks could only possibly be applied to the present hash function for only a few rounds.

Integral (or “square”) attacks were first launched against the block cipher Square. In general, it is applicable to any Rijndael-like cipher, and it exploits the fact that the S-boxes are invertible. Unlike ciphers, where integral attacks lead to a key recovery, for hash functions, the additional rounds before and after the square property cannot be efficiently exploited. Thus, since the present hash function is a Rijndael-based hash function, the integral property can be exploited and integral attacks for Hash can be launched only for a few rounds, on the order of three to five rounds, for example.

Rotational attacks follow the expansion through the rounds of the primitive of a pair of inputs where the second is a rotation of the first; i.e., each word (or possibly a byte or a column) of the second state is produced by rotating the corresponding word of the first state. In general, rotational analysis is applicable to addition-rotation-XOR primitives, however byte-oriented ciphers and hash function can be susceptible when the underlying transformations are rotational-friendly. The main method for achieving resistance against rotational attacks is the use of constants. In Hash, this is achieved by the AddRoundKey transformation. It should be noted that the key schedule assures that no rotational subkey pair can be produced in several consecutive rounds. Thus, it can be concluded that rotational analysis is possibly applicable only to a few rounds of the compression function.

The methods of analysis of byte-oriented primitives are relatively well known and such methods have been discussed above. In the present method, the state and the key have the same size and use very similar transformations. A possible attack that might exploit this type of property is one in which the adversary switches the key and the plaintext and produces the same ciphertext; i.e., EK(P)=EP(K). However, to launch such an attack, the transformations should be the same or, at least, similar. In this case, the property might work for particular inputs only. The transformations in the state and in the key schedule differ at two places, namely in ShiftRows and key/constant addition. If, at the input of ShiftRows, the state and the subkey have the same value, then this will remain the same at the output only if all the bytes within the row are equal. To achieve the same property for the addition, AddRoundKey and AddRoundConstant should be the same as well; i.e., the constant has to coincide with the subkey. However, since in AddRoundConstant the last row byte constants are different, the output of the next application of ShiftRows will not produce equal values for the last row. Thus, the present hash function resists this type of distinguisher. A comparison between the 256-bit, 512-bit and n-bit implementations of Hash against ideal security levels, as described in detail above, is summarized in Table 5 below.

TABLE 5
Comparison of Security Levels of Hash with Ideal Hash Function

| Hash | Collision | Pre-image | Second Pre-image | Distinguisher |
|---|---|---|---|---|
| Hash-256 | 2¹²⁸ | 2²⁵⁶ | 2²⁵⁶ | 2²⁵⁶ |
| Ideal-256 | 2¹²⁸ | 2²⁵⁶ | 2²⁵⁶ | 2²⁵⁶ |
| Hash-512 | 2²⁵⁶ | 2⁵¹² | 2⁵¹² | 2⁵¹² |
| Ideal-512 | 2²⁵⁶ | 2⁵¹² | 2⁵¹² | 2⁵¹² |
| Hash-n | 2^{n/2} | 2ⁿ | 2ⁿ | 2^{t} |
| Ideal-n | 2^{n/2} | 2ⁿ | 2ⁿ | 2^{t} |

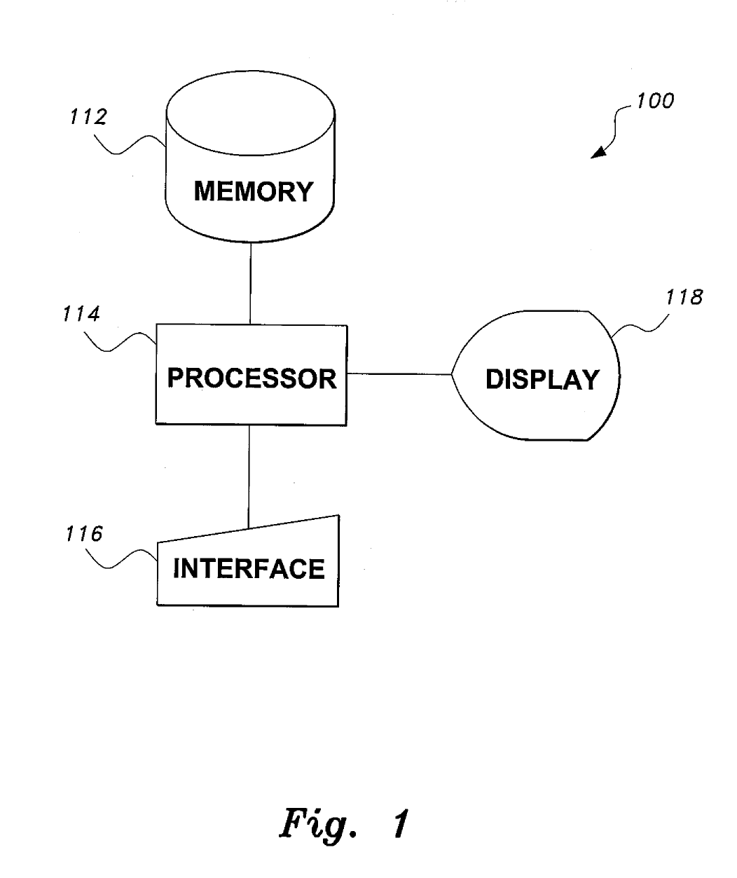

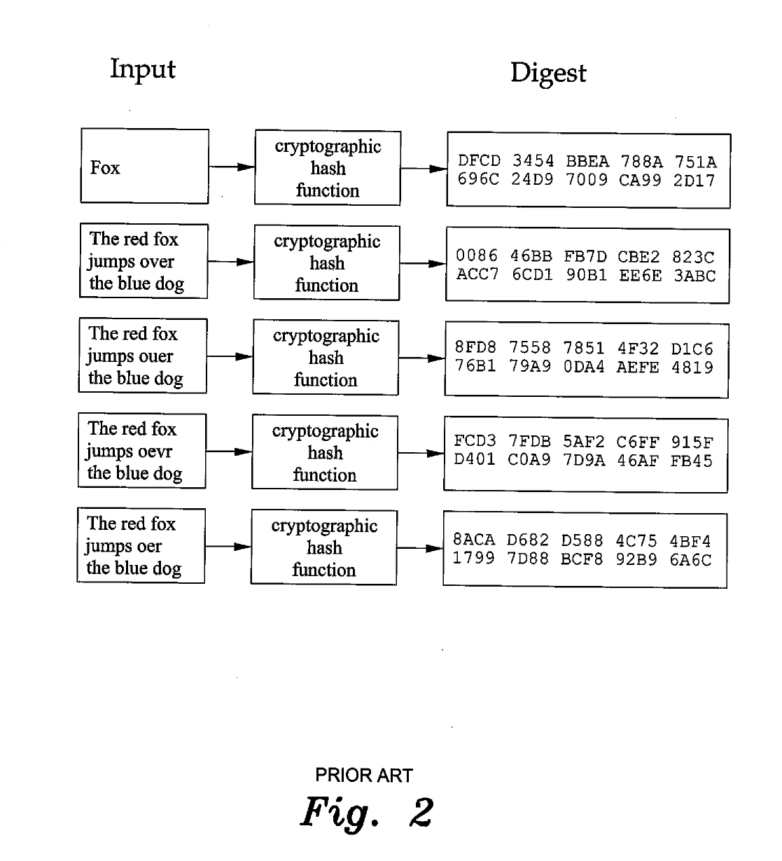

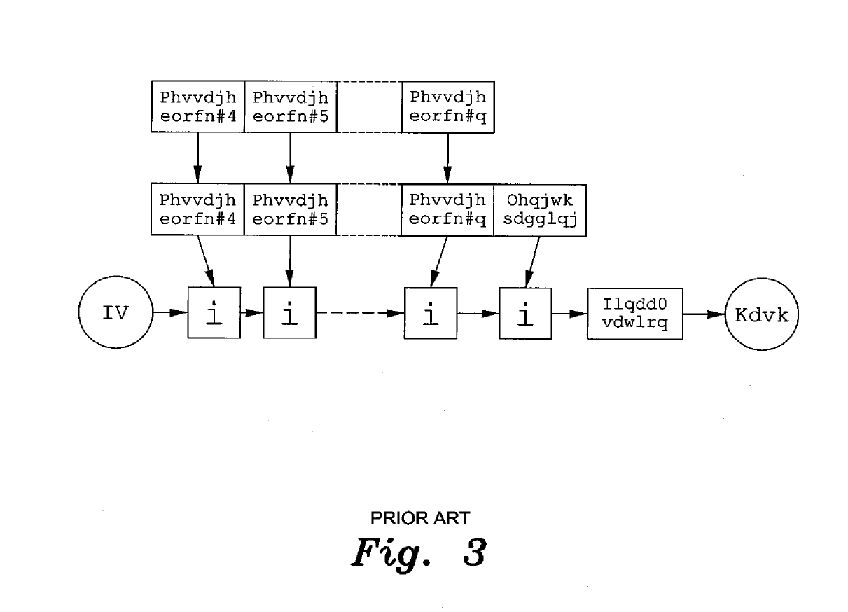

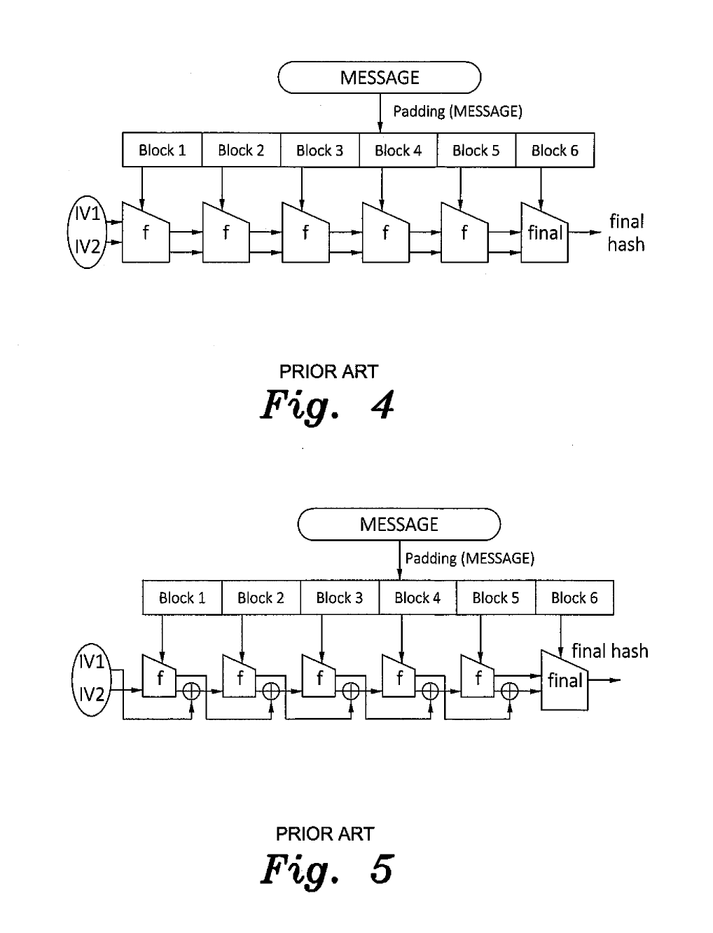

It should be understood that the calculations and instructions in embodiments for generating a secure cryptographic hash can be performed by any suitable computer system, such as that diagrammatically shown in FIG. 1. Data is entered into system 100 via any suitable type of user interface 116, and can be stored in memory 112, which can be any suitable type of computer readable and programmable memory and is desirably a non-transitory, computer readable storage medium. Calculations and implementation of instructions are performed by processor 114, which can be any suitable type of computer processor and can be displayed to the user on display 118, which can be any suitable type of computer display.

Processor 114 can be associated with, or incorporated into, any suitable type of computing device, for example, a personal computer or a programmable logic controller. The display 118, the processor 114, the memory 112 and any associated computer readable recording media are in communication with one another by any suitable type of data bus, as is well known in the art.

Examples of computer-readable recording media include non-transitory storage media, a magnetic recording apparatus, an optical disk, a magneto-optical disk, and/or a semiconductor memory (for example, RAM, ROM, etc.). Examples of magnetic recording apparatus that can be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable storage media include all computer-readable media, with the sole exception being a transitory, propagating signal.

It is to be understood that the present invention is not limited to the embodiments described above, but encompasses any and all embodiments within the scope of the following claims.

1. A computer software product that includes a non-transitory storage medium readable by a processor, the non-transitory storage medium having stored thereon a set of instructions for generating a secure cryptographic hash function, the instructions consisting of:
(a) a first set of instructions which, when loaded into main memory and executed by the processor, causes the processor to iteratively, for i=0 to 15, where i is an integer, apply an operation R on a state S of a block cipher C and an i-th subkey Kᵢ, where R=AK(S,Kᵢ)∘MC(S)∘SR(S)∘SB(S), where AK is a cryptographic AddRoundKey transformation, MC is a cryptographic MixColumns transformation, SR is a cryptographic ShiftRows transformation and SB is a cryptographic SubBytes transformation, where the SubBytes transformation applies an invertible S-box to all bytes of the state S of the block cipher C and the subkey, where the invertible S-box in a hexadecimal representation is defined as:

| | 0 | 1 | 2 | 3 | 4 | 5 | 6 | 7 | 8 | 9 | a | b | c | d | e | f |
|---|---|---|---|---|---|---|---|---|---|---|---|---|---|---|---|---|
| 0 | 63 | 7c | 77 | 7b | f2 | 6b | 6f | c5 | 30 | 01 | 67 | 2b | fe | d7 | ab | 76 |
| 1 | ca | 82 | c9 | 7d | fa | 59 | 47 | f0 | ad | d4 | a2 | af | 9c | a4 | 72 | c0 |
| 2 | b7 | fd | 93 | 26 | 36 | 3f | f7 | cc | 34 | a5 | e5 | f1 | 71 | d8 | 31 | 15 |
| 3 | 04 | c7 | 23 | c3 | 18 | 96 | 05 | 9a | 07 | 12 | 80 | e2 | eb | 27 | b2 | 75 |
| 4 | 09 | 83 | 2c | 1a | 1b | 6e | 5a | a0 | 52 | 3b | d6 | b3 | 29 | e3 | 2f | 84 |
| 5 | 53 | d1 | 00 | ed | 20 | fc | b1 | 5b | 6a | cb | be | 39 | 4a | 4c | 58 | cf |
| 6 | d0 | ef | aa | fb | 43 | 4d | 33 | 85 | 45 | f9 | 02 | 7f | 50 | 3c | 9f | a8 |
| 7 | 51 | a3 | 40 | 8f | 92 | 9d | 38 | f5 | bc | b6 | da | 21 | 10 | ff | f3 | d2 |
| 8 | cd | 0c | 13 | ec | 5f | 97 | 44 | 17 | c4 | a7 | 7e | 3d | 64 | 5d | 19 | 73 |
| 9 | 60 | 81 | 4f | dc | 22 | 2a | 90 | 88 | 46 | ee | b8 | 14 | de | 5e | 0b | db |
| a | e0 | 32 | 3a | 0a | 49 | 06 | 24 | 5c | c2 | d3 | ac | 62 | 91 | 95 | e4 | 79 |
| b | e7 | c8 | 37 | 6d | 8d | d5 | 4e | a9 | 6c | 56 | f4 | ea | 65 | 7a | ae | 08 |
| c | ba | 78 | 25 | 2e | 1c | a6 | b4 | c6 | e8 | dd | 74 | 1f | 4b | bd | 8b | 8a |
| d | 70 | 3e | b5 | 66 | 48 | 03 | f6 | 0e | 61 | 35 | 57 | b9 | 86 | c1 | 1d | 9e |
| e | e1 | f8 | 98 | 11 | 69 | d9 | 8e | 94 | 9b | 1e | 87 | e9 | ce | 55 | 28 | df |
| f | 8c | a1 | 89 | 0d | bf | e6 | 42 | 68 | 41 | 99 | 2d | 0f | b0 | 54 | bb | 16; |

(b) a second set of instructions which, when loaded into main memory and executed by the processor, causes the processor to iteratively, for i=0 to 15, transform the i-th subkey Kᵢ as Kᵢ₊₁=AC∘MC∘SR∘SB(Kᵢ), where AC is a cryptographic AddRoundConstant transformation and K₀ is an initial master key;
(c) a third set of instructions which, when loaded into main memory and executed by the processor, causes the processor to define a compression function CF iteratively, for t=0 to 15, as Hᵢ₊₁=CF(Hᵢ,Mᵢ)=C(Hᵢ,Mᵢ)⊕Hᵢ, where Hᵢ is an i-th chaining value, Mᵢ is an i-th message block, and H₀ is a fixed initial chaining value, where the iterative compression operation Hᵢ₊₁=CF(Hᵢ,Mᵢ) pads the set of message blocks to an expanded message containing l blocks, where l is an integer; and
(d) a fourth set of instructions which, when loaded into main memory and executed by the processor, causes the processor to truncate the l-th chaining value Hₗ₊₁ to output n left-most bits of Hₗ₊₁, where n represents a size of an initial message digest, the truncated chaining value being a secure cryptographic hash function;
wherein the secure cryptographic hash function has a wide pipe construction in which an intermediate chaining value is at least twice the length of the output hash provides security against cipher attacks.

2. A computer software product that includes a non-transitory storage medium readable by a processor, the non-transitory storage medium having stored thereon a set of instructions for generating a secure cryptographic hash function having a wide pipe construction in which an intermediate chaining value is at least twice the length of the output hash, the instructions consisting of:
(a) a first set of instructions which, when loaded into main memory and executed by the processor, causes the processor to iteratively apply an operation R on a state S of a block cipher C and an i-th subkey Kᵢ, where R=AK(S,Kᵢ)∘MC(S)∘SR(S)∘SB(S), where i is an integer, AK is a cryptographic AddRoundKey transformation, MC is a cryptographic MixColumns transformation, SR is a cryptographic ShiftRows transformation and SB is a cryptographic SubBytes transformation, where the SubBytes transformation applies an invertible S-box to all bytes of the state S of the block cipher C and the subkey,
wherein the invertible S-box is in a form of a hexadecimal representation:
wherein the SB transformation transforms a_{i,j}^{new}=S(a_{i,j}^{old}) and b_{i,j}^{new}=S(b_{i,j}^{old}), the SR transformation performs a cyclic shift of the rows of a state matrix and a key matrix on offsets corresponding to a row index, wherein a value of the offsets rₐⁱ and r_{b}ⁱ transform
$${a}_{i , j}^{new} = {a}_{i , j + {r}_{a}^{i}}^{old} and {b}_{i , j}^{new} = {b}_{i , j + {r}_{b}^{i}}^{old} ,$$
the individual bytes of a state matrix corresponding to the state S being represented as a_{i,j} and the individual bytes of a key matrix corresponding to the subkey being represented as b_{i,j}, the MC transformation performs a diffusion among the bytes by a multiplication of the columns aⱼ, bⱼ of a state matrix corresponding to the state S and a key matrix corresponding to the subkey, respectively, by a matrix M with aⱼ^{new}=M·aⱼ^{old} and bⱼ^{new}=M·bⱼ^{old}, and the AK transformation performs an operation on the subkey to the state S as a_{i,j}^{new}=a_{i,j}^{old}⊕b_{i,j};
(b) a second set of instructions which, when loaded into main memory and executed by the processor, causes the processor to iteratively transform the i-th subkey Kᵢ as Kᵢ₊₁=AC∘MC∘SR∘SB(Kᵢ), where AC is a cryptographic AddRoundConstant transformation and K₀ is an initial master key;
(c) a third set of instructions which, when loaded into main memory and executed by the processor, causes the processor to define a compression function CF iteratively as Hᵢ₊₁=CF(Hᵢ,Mᵢ)=C(Hᵢ,Mᵢ)⊕Hᵢ, where Hᵢ is an i-th chaining value, Mᵢ is an i-th message block, and H₀ is a fixed initial chaining value, where the iterative compression operation Hᵢ₋₁=CF(Hᵢ,Mᵢ) pads the set of message blocks to an expanded message containing l blocks, where l is an integer; and
(d) a fourth set of instructions which, when loaded into main memory and executed by the processor, causes the processor to truncate the l-th chaining value Hₗ₊₁ to output n left-most bits of Hₗ₋₁, where n represents a size of an initial message digest, the truncated chaining value being a secure cryptographic hash function;
wherein i=0 to 15 and the value of the offsets rₐⁱ and r_{b}ⁱ transform
$${a}_{i , j}^{new} = {a}_{i , j + {r}_{a}^{i} mod 16}^{old} and {b}_{i , j}^{new} = {b}_{i , j + {r}_{b}^{i} mod 16}^{old} ;$$
wherein the secure cryptographic hash function provides security against cipher attacks.

3-11. (canceled)
